(19) United States
(12) Patent Application Publication
(10) Pub. No.: US 2018/0036832 A1
(43) Pub. Date: Feb. 8, 2018

(54) VIBRATION WELDING SYSTEM AND METHOD

(71) Applicant: GM GLOBAL TECHNOLOGY OPERATIONS LLC, Detroit, MI (US)

(72) Inventors: Teresa J. Rinker, Royal Oak, MI (US); Wayne W. Cai, Troy, MI (US); Nicholas W. Pinto, Shelby Township, MI (US); Michael P. Balogh, Novi, MI (US)

(73) Assignee: GM GLOBAL TECHNOLOGY OPERATIONS LLC, Detroit, MI (US)

(21) Appl. No.: 15/228,412

(22) Filed: Aug. 4, 2016

(51) Int. Cl. B23K 20/00; B23K 20/10

(52) U.S. Cl. CPC B23K 20/004; B23K 20/106

(57) ABSTRACT

A vibration welding system for joining a wire to a substrate includes a welding pad attached to a sonotrode and an anvil. The welding pad includes first energy directors that are disposed in a first region and second energy directors that are disposed in a second region. A channel is formed between the substrate and the first energy directors when the second energy directors are in contact with the substrate. The channel is configured to accommodate a portion of the wire, and has a depth that is less than a cross-sectional diameter of the wire. The wire and the substrate are clamped between the welding pad and the anvil during operation of the sonotrode. The first energy directors urge the wire towards the substrate during the operation of the sonotrode to effect joining of the wire to the substrate.

### TECHNICAL FIELD

The present disclosure relates to a vibration welding system.

### BACKGROUND

In a vibration welding process, adjacent surfaces of a clamped workpiece are joined using vibration energy. The transmission of vibration energy through the material of the workpiece creates surface friction and heat along interfacing workpiece surfaces. The heat causes interfacing surfaces to become malleable, which facilitates their bonding together at a resultant welded joint.

A vibration welding system preferably includes various interconnected welding devices, including a vibrating sonotrode/welding horn and an anvil assembly. The anvil assembly may include an anvil and a back plate, with the anvil being bolted or otherwise attached to a rigid support member via the back plate. A workpiece can be clamped between the horn and the anvil. The horn is then caused to vibrate at a calibrated frequency and amplitude in response to a high-frequency input signal from a controller.

### SUMMARY

A vibration welding system for joining a wire to a substrate is disclosed, and includes a welding pad attached to a sonotrode and an anvil. The welding pad includes a plurality of first energy directors that are disposed in a first region and a plurality of second energy directors that are disposed in a second region. A channel is formed between the substrate and the first energy directors when the second energy directors are in contact with the substrate. The channel is configured to accommodate the portion of the wire, and has a depth that is less than a cross-sectional diameter of the portion of the wire. The portion of the wire and the substrate are clamped between the welding pad and the anvil during operation of the sonotrode. The first energy directors are disposed to urge the portion of the wire towards the substrate during the operation of the sonotrode to effect joining of the portion of the wire to the substrate.

The above features and advantages and other features and advantages of the present disclosure are readily apparent from the following detailed description of the best modes for carrying out the disclosure when taken in connection with the accompanying drawings.

### BRIEF DESCRIPTION OF THE DRAWINGS

FIG. 1 is a schematic illustration of an example vibration welding system that is specially configured to join elements of a workpiece that includes a wire and a substrate using ultrasonic vibration, in accordance with the disclosure;

FIGS. 2 and 3 schematically show cross-sectional side views of embodiments of a welding pad and anvil that may be employed in the vibration welding system described with reference to FIG. 1 to join a workpiece that includes a wire and a substrate, in accordance with the disclosure;

FIG. 4 schematically shows a perspective side view of an embodiment of a welding pad and anvil that may be employed in the vibration welding system described with reference to FIG. 1 to join a workpiece that includes a wire and a substrate, in accordance with the disclosure;

FIG. 5 schematically shows a cross-sectional side view of an embodiment of a welding pad and anvil that may be employed in the vibration welding system described with reference to FIG. 1 to join a workpiece that includes a wire and a substrate, in accordance with the disclosure;

FIGS. 6-1 and 6-2 schematically show a cross-sectional side view and a corresponding cross-sectional end view, respectively, of another embodiment of a welding pad and anvil that may be employed in the vibration welding system described with reference to FIG. 1 to join a workpiece that includes butted ends of a first wire and a second wire, and a cover sheet in accordance with the disclosure; and

FIG. 7 schematically shows a cross-sectional bottom-view of another embodiment of a welding pad that includes a first region having a channel and a second region, wherein the channel is a continuous arc that includes an insert point and an exit point on a side portion of the welding pad, in accordance with the disclosure.

### DETAILED DESCRIPTION

The components of the disclosed embodiments, as described and illustrated herein, may be arranged and designed in a variety of different configurations. Thus, the following detailed description is not intended to limit the scope of the disclosure, as claimed, but is merely representative of possible embodiments thereof. In addition, while numerous specific details are set forth in the following description in order to provide a thorough understanding of the embodiments disclosed herein, some embodiments can be practiced without some or all of these details. Moreover, for the purpose of clarity, certain technical material that is known in the related art has not been described in detail in order to avoid unnecessarily obscuring the disclosure. Furthermore, the drawings are in simplified form and are not to precise scale. For purposes of convenience and clarity only, directional terms such as top, bottom, left, right, up, over, above, below, beneath, rear, and front, may be used with respect to the drawings. These and similar directional terms are not to be construed to limit the scope of the disclosure in any manner.

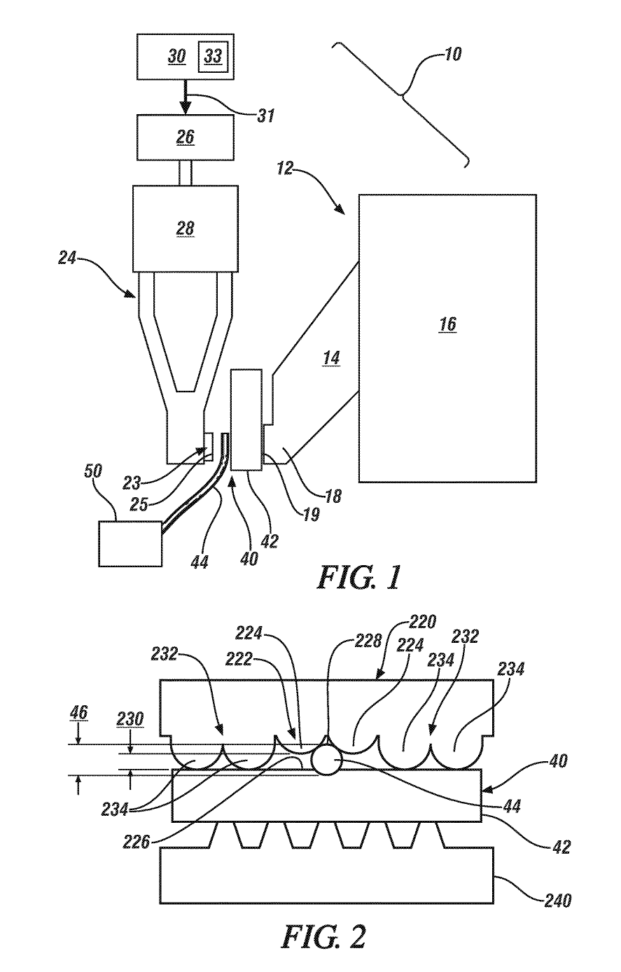

Referring to the drawings, wherein like reference numbers refer to like components, a vibration welding system 10 is shown in FIG. 1. Those of ordinary skill in the art will appreciate that the vibration welding system 10 may operate at an ultrasonic frequency or within another frequency range without departing from the scope of the disclosure. The vibration welding system 10 described herein is specially configured to form a welded joint in a workpiece 40 that includes a portion of a wire 44 and a substrate 42 using ultrasonic vibration. The wire 44 is a single strand that is fabricated from a shape memory alloy (SMA) material, a high tensile strength material, or another suitable material, and is preferably cylindrically-shaped. One feature of the welded joint that is formed in the workpiece 40 is that the portion of the wire 44 that is joined to the substrate 42 retains its cross-sectional shape and is free from gouging, scoring or witness marks.

The vibration welding system 10 includes an anvil assembly 12 and a vibrating sonotrode or welding horn 24. The anvil assembly 12 preferably includes a backplate 16 on which an anvil 14 is disposed, and the anvil 14 includes an anvil welding pad 18 having a welding surface 19. The anvil assembly 12 provides a relatively stiff mass that is sufficient for opposing the welding horn 24 during the welding process. The welding surface 19 of the anvil welding pad 18 preferably has a knurled pattern in the form of, e.g., raised bumps, ridges, or any other textured pattern to provide traction for gripping the workpiece 40 during the welding process.

The welding horn 24 includes a welding power supply 30, a converter 26, a booster 28 and a welding pad 23. The welding power supply 30 may include a welding controller 33 as part of the power supply (as shown) or as a separate device. The welding power supply 30 may be advantageously employed to transform available source power into a form that is more conducive to vibration welding to drive and control the vibration welding process. For instance, the power supply 30 may be electrically connected to any suitable energy source, e.g., a 50-60 Hz AC wall socket. In this instance the power supply 30 may include voltage rectifiers and inverters for generating a high-frequency waveform suitable for vibration welding. The power supply 30 and the welding controller 33 transform source power into a suitable power control signal having a predetermined waveform characteristic(s) suited for use in the vibration welding process, for example a frequency of several Hertz (Hz) to about 40 KHz, or higher frequencies depending on the particular application. The converter 26 may be in the form of a piezoelectric stack or another configuration that has the required mechanical structure for producing a mechanical vibration in response to the input signal (arrow 31). The booster 28 amplifies the amplitude of vibration of the input signal (arrow 31) at a calibrated frequency, and/or changes a direction of any applied clamping force between the welding horn 24 and the anvil 14. The welding pad 23 includes a joining surface 25 that works in conjunction with the welding surface 19 of the anvil welding pad 18 to securely grip the workpiece 40 during the vibration welding process.

A wire feeder 50 may be disposed to supply to the vibration welding system 10 a portion of the wire 44 for joining to the substrate 42 as part of the workpiece 40. The wire feeder 50 may have the capability to pre-bend, cut and insert the wire 44 into the vibration welding system 10 in one embodiment. Alternatively, the wire feeder 50 may include a continuous spool of the wire 44 that is fed through a channel in the welding horn 24 to form a desired shape prior to welding. The wire feeder 50 may insert the wire 44 into the vibration welding system 10 without bending it in one embodiment. In one embodiment, the welding controller 33 of the vibration welding system 10 including suitable positioning elements and sensors to control a position of the control of the welding horn 24 with regard to a position of the workpiece 40 to provide a wire guide for the wire feeder 50 prior to executing the welding process. In one embodiment, this can be in the form of a multi-step closing sequence, which permits closing of the welding horn 24 to the anvil 14 at a first, low level clamping pressure for wire guiding, and then closing of the welding horn 24 to the anvil 14 at a second, high level clamping pressure for vibration welding.

Embodiments of the welding pad and joining surface are described herein with reference to FIG. 2, et seq. In each of the embodiments, the welding pad includes a first region that may include a plurality of first energy directors that project from the welding pad, and a second region that includes a plurality of second energy directors that project from the welding pad. As used herein, the term “energy director” refers to a portion of material that projects orthogonally from the surface of the welding pad, and may be in the shape of a pyramid or another suitable three-dimensional shape, as described herein. Placement of the welding pad against the substrate generates a channel between the substrate and the first energy directors when the second energy directors are in contact with the substrate, wherein the channel is configured to accommodate a length portion of the wire. The channel has a depth that is preferably less than a cross-sectional diameter of the portion of the wire. When a portion of the wire and the substrate are clamped between the welding pad and the anvil during operation of the sonotrode, the first energy directors are disposed to urge the portion of the wire towards the substrate and the second energy directors are disposed to act upon the surface of the substrate to effect joining of the portion of the wire to the substrate. The primary function of the second energy directors is to propagate and concentrate the vibration energy that is generated by the welding horn 24 in a localized area of the surface of the substrate to soften and melt its material to facilitate forming of a welded joint between the wire and the substrate of the workpiece.

FIG. 2 schematically shows a cross-sectional side view of a first embodiment of a welding pad 220 and anvil 240 that may be employed in the vibration welding system 10 described with reference to FIG. 1. The welding pad 220 and anvil 240 may be advantageously employed to join a portion of the wire 44 to the substrate 42 of the workpiece 40 such that the wire 44 retains its cross-sectional shape and is free from gouging, scoring or witness marks in the resulting welded joint. The wire 44 is depicted as having a circular cross-section with a diameter 46, which is one embodiment. The cross-sectional shape of the wire 44 may be any suitable shape, including, e.g., a square cross-section, an oval cross-section, a hexagonal cross-section, etc.

In this embodiment, the welding pad 220 includes a first region 222 that includes a plurality of first energy directors 224 and a second region 232 that includes a plurality of second energy directors 234. In one embodiment, the first and second energy directors 224, 234 are formed by knurling, and may be in the form of a straight pattern, an angled pattern or a diamond-shaped pattern, and arranged in a coarse, medium or fine density. Alternatively, the first and second energy directors 224, 234 may be machined into the shape of hemispherical bodies, pyramids, truncated pyramids or other suitable shapes.

The first energy directors 224 and the second energy directors 234 project from the welding pad 220 at different heights in this embodiment, such that placement of the welding pad 220 against the substrate 42 generates a channel 228 between the substrate 42 and the opposed first energy directors 224 when the second energy directors 234 are in contact with the substrate 42. The channel 228 is configured to accommodate a portion of the wire 44. The channel 228 has a depth 230 that is preferably less than a cross-sectional diameter 46 of the portion of the wire 44 that is inserted or otherwise placed in the channel 228 prior to the workpiece 40 being clamped into the vibration welding system 10. During vibration welding, the second energy directors 234 act upon the substrate 42 and the first energy directors 224 act upon the wire 44. The action of the second energy directors 234 causes the substrate 42 to become malleable, and the clamping force acting upon the first energy directors 224 of the welding pad 220 and the anvil 240 urges the portion of the wire 44 into the malleable substrate 42 at a joining surface 226 to effect the joining.

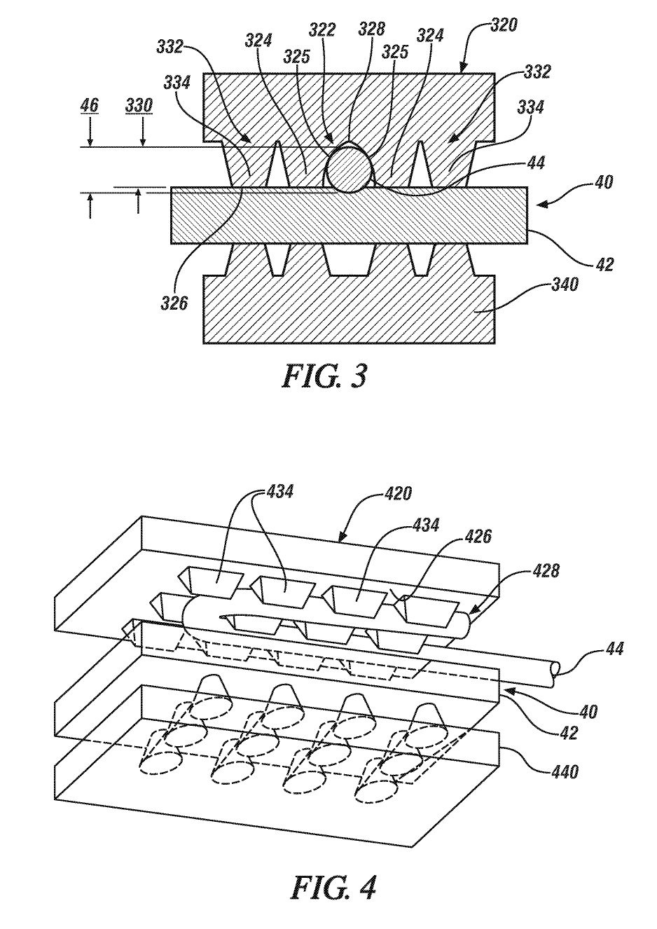

FIG. 3 schematically shows a cross-sectional side view of another embodiment of a welding pad 320 and anvil 340 that may be employed in the vibration welding system 10 described with reference to FIG. 1. The welding pad 320 and anvil 340 may be advantageously employed to join the wire 44 to the substrate 42 of the workpiece 40 such that the wire 44 retains its cross-sectional shape in the finished workpiece 40 and is free from gouging, scoring or witness marks in the resulting welded joint. The wire 44 is depicted as having a circular cross-section with diameter 46, which is one embodiment. The cross-sectional shape of the wire 44 may be any suitable shape, including, e.g., a square cross-section, an oval cross-section, a hexagonal cross-section, etc. In this embodiment, the welding pad 320 includes a first region 322 that includes a plurality of first energy directors 324 that project from the welding pad 320, and a second region 332 that includes a plurality of second energy directors 334 that project from the welding pad 320.

The first energy directors 324 and the second energy directors 334 project from the welding pad 320 at the same heights in this embodiment. The first energy directors 324 each include concave side portions 325. The first energy directors 324 are situated such that opposed concave side portions 325 form a channel 328 between the substrate 40 and the first energy directors 324 when the second energy directors 334 are in contact with the substrate 42. The channel 328 is configured to accommodate a portion of the wire 44. The channel 328 has a depth 330 that is preferably less than a cross-sectional diameter 46 of the portion of the wire 44 that is inserted or otherwise placed in the channel 328 prior to the workpiece 40 being clamped into the vibration welding system 10. During vibration welding, the second energy directors 334 act upon the substrate 42 and the concave side portions 325 of the first energy directors 324 act upon the wire 44. The action of the second energy directors 334 causes the substrate 42 to become malleable, and the clamping force acting upon the concave side portions 325 of the first energy directors 324 of the welding pad 320 and the anvil 340 urges the portion of the wire 44 into the malleable substrate 42 at a joining surface 326 to effect the joining.

FIG. 4 schematically shows a perspective side view of another embodiment of a welding pad 420 and anvil 440 that may be employed in the vibration welding system 10 described with reference to FIG. 1. The welding pad 420 and anvil 440 may be advantageously employed to join a portion of the wire 44 to the substrate 42 of the workpiece 40 such that the wire 44 retains its cross-sectional shape in the finished workpiece 40 and is free from gouging, scoring or witness marks in the resulting welded joint. In this embodiment, the portion of the wire 44 that is joined to the substrate 42 may be arranged in a C-shape, or may otherwise double back on itself.

In this embodiment, the welding pad 420 includes a plurality of second energy directors 434 that project from a welding pad surface 426 of the welding pad 420. The second energy directors 434 project to a common projection height relative to the welding pad 420 as it contacts the substrate 42 of the workpiece 40 when clamped into the vibration welding system 10. In this embodiment, the welding pad surface 426 of the welding pad 420 functions to urge the wire 44 into the substrate 42 during vibration welding.

In this embodiment, the second energy directors 434 have frustoconical shapes, i.e., frustums that are arranged on the welding pad 420 such that the welding pad surface 426 is exposed on the surface of the welding pad 420. Alternatively, the second energy directors 434 may have hemispherical shapes, or another suitable shape. A channel 428 having a C-shape or another suitable arrangement is preferably formed between the second energy directors 434 in the welding pad surface 426, and the wire 44 can be threaded therethrough prior to welding. The depth that is associated with the second energy directors 434 is selected based upon a diameter of the wire 44, and is preferably less than a diameter of the wire 44. Preferably, the second energy directors 434 are disposed on the welding pad surface 426 such that the channel 428 is formed to accommodate the wire 44. In one embodiment, the second energy directors 434 are formed by machining. During vibration welding, the second energy directors 434 act upon the substrate 42, and the wire 44 is inserted in the channel 428. In one embodiment, the wire 44 is preformed; alternatively, the wire 44 may be fed into the channel 428 with trimming of any extraneous portion. The action of the second energy directors 434 causes the substrate 42 to become malleable, and the clamping force acting upon the wire 44 from the welding pad surface 426 urges the wire 44 into the malleable substrate 42 to effect the joining.

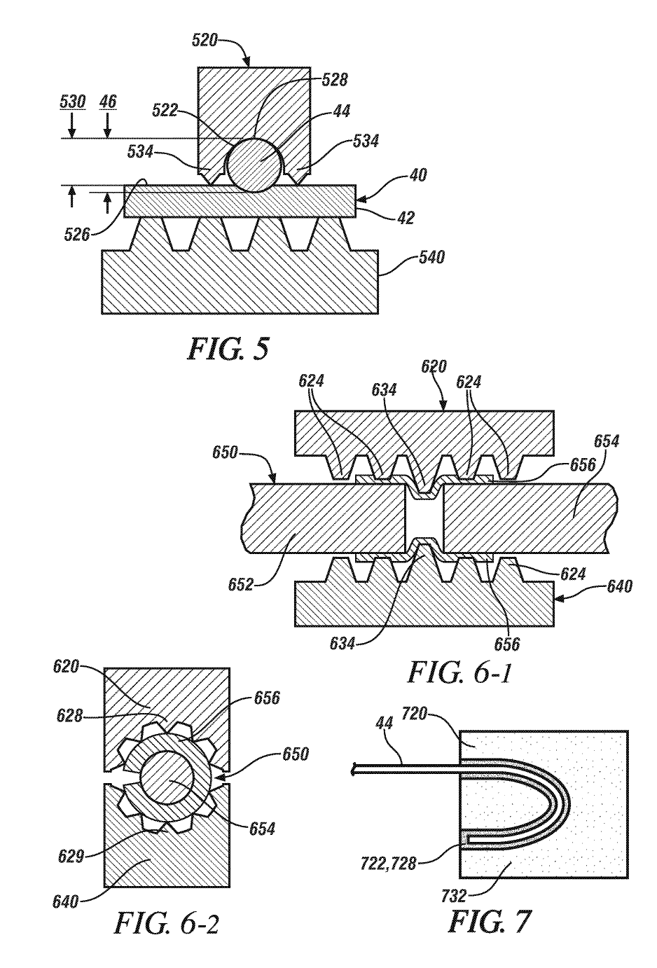

FIG. 5 schematically shows a cross-sectional side view of another embodiment of a welding pad 520 and anvil 540 that may be employed in the vibration welding system 10 described with reference to FIG. 1. The welding pad 520 and anvil 540 may be advantageously employed to join a portion of the wire 44 to the substrate 42 of the workpiece 40 such that the wire 44 retains its cross-sectional shape in the finished workpiece 40 and is free from gouging, scoring or witness marks in the resulting welded joint. In this embodiment, the portion of the wire 44 that is joined to the substrate 42 may be arranged in a straight line, a C-shape, or otherwise doubles back on itself. The wire 44 is depicted as having a circular cross-section with diameter 46, which is one embodiment. The cross-sectional shape of the wire 44 may be any suitable shape, including, e.g., a square cross-section, an oval cross-section, a hexagonal cross-section, etc. In this embodiment, the welding pad 520 includes a channel 522 that is annular to a portion of the cross-section of the wire 44 and is arranged to circumscribe the portion of the wire 44 that is being joined to the substrate 42. A plurality of second energy directors 534 project from the welding pad 520, and form a channel 528 that has a projection depth 530 relative to a joining surface 526 as it contacts the substrate 42 of the workpiece 40 when clamped into the vibration welding system 10. The second energy directors 534 project to a common projection height relative to the welding pad 520 as it contacts the substrate 42 of the workpiece 40 when clamped into the vibration welding system 10. In this embodiment, the welding pad 520 surrounding the channel 528 functions to urge the wire 44 into the substrate 42 during vibration welding. In this embodiment, the tips of the second energy directors 534 preferably have pyramid shapes, and are arranged on the welding pad 520 such that their tips contact the joining surface 526. Alternatively, the second energy directors 534 may have another suitable shape. The wire 44 can be threaded through the channel 528 prior to welding. The projection depth 530 may be selected based upon the diameter 46 of the wire 44. Preferably, the second energy directors 534 are disposed on the joining surface 526 such that the channel 528 is formed to accommodate the wire 44. In one embodiment, the second energy directors 534 are formed by machining. During vibration welding, the second energy directors 534 act upon the substrate 42, and the wire 44 is inserted in the channel 528. In one embodiment, the wire 44 is preformed; alternatively, the wire 44 may be fed into the channel 528 with trimming of any extraneous portion. The action of the second energy directors 534 causes the substrate 42 to become malleable, and the clamping force acting upon the wire 44 urges the wire 44 into the malleable substrate 42 to effect the joining.

FIGS. 6-1 and 6-2 schematically show a cross-sectional side view and a corresponding cross-sectional end view of another embodiment of a welding pad 620 and anvil 640 that may be employed in the vibration welding system 10 described with reference to FIG. 1. The welding pad 620 and anvil 640 may be advantageously employed to join a workpiece 650 that includes butt-joined ends of a portion of a first wire 652 and a portion of a second wire 654, and a substrate that is in the form of a cover sheet 656. The first and second wires 652, 654 may be opposite ends of a single strand of cable, thus forming a continuous loop, or alternatively, may be ends of two different strands. The cover sheet 656 may be fabricated as a cylindrical tube forming an inner portion that has first and second ends into which the first and second wires 652, 654, respectively, may be inserted. The vibration welding system 10 joins the first and second wires 652, 654 employing the cover sheet 656 such that first and second wires 652, 654 both retain their respective cross-sectional shapes in the finished workpiece 650 and are free from gouging, scoring or witness marks in the resulting welded joint.

In this embodiment, the welding pad 620 includes a first channel 628 that is annular to a portion of the cross-section of the first wire 652 and is arranged to circumscribe the portion of the cross-section of the first wire 652. The anvil 640 includes a second channel 629 that is preferably oriented in an opposed manner to the first channel 628. Together the first channel 628 and the second channel 629 circumscribe an outer circumference of the cover sheet 656 and the first and second wires 652, 654.

A plurality of inwardly-directed first energy directors 624 are circumferentially disposed on the first channel 628 and the second channel 629, wherein the first energy directors 624 contact the cover sheet 656 and one of the first and second wires 652, 654. A plurality of inwardly-directed second energy directors 634 are circumferentially disposed on the first channel 628 and the second channel 629, wherein the first energy directors 624 contact only the cover sheet 656, and are located between the joined ends of the first and second wires 652, 654.

The first energy directors 624 project to a common projection height relative to the cover sheet 656 and one of the first and second wires 652, 654 when the workpiece 650 is clamped into the vibration welding system 10.

The first energy directors 624 may have any suitable shapes. During vibration welding, the first energy directors 624 act upon the cover sheet 656 and one of the first and second wires 652, 654. The action of the first energy directors 624 causes the cover sheet 656 and the first and second wires 652, 654 to become malleable, and the clamping force urges the joining of the cover sheet 656 and one of the first and second wires 652, 654. The second energy director 634 urges the cover sheet 656 into any gap that exists between the butted portions of the first and second wires 652, 654.

FIG. 7 schematically shows a cross-sectional bottom-view of another embodiment of a welding pad 720 that includes a first region 722 that includes a channel 728 and a second region 732. The channel 728 is disposed to accommodate a portion of the wire 44. The second region 732 is a knurled surface. The channel 728 is formed therein as a continuous arc that preferably includes an insert point and an exit point on a side portion of the welding pad 720. The face of the welding pad 720 is disposed to physically contact a substrate (not shown) to effect vibration welding of the portion of the wire 44 thereto. This configuration permits a wire feeder, e.g., the wire feeder 50 described with reference to FIG. 1, to feed a portion of the wire 44 into the channel 728, with the portion of the wire 44 bending in the continuous arc and emerging at the exit point. The sonotrode (not shown) can be activated to effect vibration welding of the portion of the wire 44 to the substrate employing the second region 732 to effect the vibration welding with normal force applied to the portion of the wire 44 via the channel 728. The wire feeder 50 can include a device that trims any excess wire after the vibration welding is completed.

While the best modes for carrying out the disclosure have been described in detail, those familiar with the art to which this disclosure relates will recognize various alternative designs and embodiments for practicing the disclosure within the scope of the appended claims.

1. A vibration welding system for joining a portion of a wire to a substrate, comprising:
an anvil and a welding pad attached to a sonotrode;
the welding pad including a plurality of first energy directors that are disposed in a first region and a plurality of second energy directors that are disposed in a second region;
wherein a channel is formed between the substrate and the first energy directors when the second energy directors are in contact with the substrate;
wherein the channel is configured to accommodate the portion of the wire;
wherein the channel has a depth that is less than a cross-sectional diameter of the portion of the wire;
wherein the portion of the wire and the substrate are clamped between the welding pad and the anvil during operation of the sonotrode; and
wherein the first energy directors are disposed to urge the portion of the wire towards the substrate during the operation of the sonotrode to effect joining of the portion of the wire to the substrate.

2. The vibration welding system of claim 1, wherein the wire is fabricated from a shape-memory alloy.

3. The vibration welding system of claim 1, wherein the wire is fabricated from a high tensile-strength alloy.

4. The vibration welding system of claim 1, wherein the substrate is contiguous to the anvil and the wire is contiguous to the welding pad.

5. The vibration welding system of claim 1, wherein each of the second energy directors is configured as a frustum.

6. The vibration welding system of claim 1, wherein a tip portion of each of the first and second energy directors is configured as a hemisphere.

7. The vibration welding system of claim 1, wherein the first energy director comprises a welding pad surface and the second energy directors comprise frustums that are arranged on the welding pad such that the welding pad surface is exposed, wherein the welding pad surface is disposed to urge the portion of the wire towards the substrate during the operation of the sonotrode.

8. The vibration welding system of claim 1, wherein the first energy directors each include concave side portions, wherein opposed ones of the concave side portions form the channel between the substrate and the first energy directors when the second energy directors are in contact with the substrate, wherein opposed ones of the concave side portions of the first energy directors are disposed to urge the portion of the wire towards the substrate during the operation of the sonotrode.

9. The vibration welding system of claim 1, wherein the first energy directors project from the welding pad at a first height, wherein the second energy directors project from the welding pad at a second height that is greater than the first height, and wherein placement of the welding pad against the substrate forms the channel between the substrate and the first energy directors when the second energy directors are in contact with the substrate.

10. The vibration welding system of claim 1, further comprising a wire feeder that is disposed to supply the portion of the wire to the vibration welding system.

11. The vibration welding system of claim 10, wherein the wire feeder pre-bends and inserts the wire portion into the vibration welding system prior to the operation of the sonotrode to effect joining of the portion of the wire to the substrate.

12. The vibration welding system of claim 10, wherein the wire feeder is disposed to feed wire from the continuous spool through the channel to form a preferred shape prior to operation of the sonotrode to effect joining of the portion of the wire to the substrate.

13. A vibration welding system for joining a first wire to a second wire, comprising:
a workpiece including an end portion of the first wire, an end portion of the second wire, and a cover sheet in the form of a cylindrical hollow tube having a first end and a second end, wherein the end portion of the first wire is inserted into the first end of the cover sheet and the end portion of the second wire is inserted into the second end of the cover sheet;
an anvil and a welding pad attached to a sonotrode;
the welding pad formed in a semi-cylindrical shape and including a plurality of first energy directors that are disposed in a first region, wherein the first energy directors are radially-oriented and inwardly-projecting;
the anvil including a portion formed in a semi-cylindrical shape and including a plurality of the first energy directors that are disposed in the first region, wherein the first energy directors are radially-oriented and inwardly-projecting;
wherein a channel is formed between the welding pad and the anvil;
wherein the channel is configured to accommodate the workpiece;
wherein the workpiece is clamped between the welding pad and the anvil during operation of the sonotrode; and
wherein the first energy directors are disposed to urge the first and second ends of the substrate towards the respective end portions of the first and second wires during the operation of the sonotrode to effect joining of the first and second wires.

14. The vibration welding system of claim 13, wherein the end portions of the first and second wire comprise opposite ends of a single strand of wire.

15. The vibration welding system of claim 13, wherein the wire is fabricated from a shape-memory alloy.

16. The vibration welding system of claim 13, wherein the wire is fabricated from a high tensile-strength alloy.

17. The vibration welding system of claim 13, further comprising a plurality of second energy directors that are disposed in a second region, wherein the second region is disposed at a butt junction of the end portion of the first wire and the end portion of the second wire, and wherein the second energy directors are radially-oriented and inwardly-projecting.

18. A method for joining a wire to a substrate employing a vibration welding system that includes a sonotrode disposed with a welding pad and an anvil, the method comprising:
clamping the wire and the substrate between the sonotrode and the anvil; and
vibrationally exciting the sonotrode;
wherein the welding pad includes a first region and a second region, wherein the first region includes a plurality of first energy directors, and the second region includes a plurality of second energy directors;
wherein a channel is formed between the substrate and the first energy directors when the second energy directors are in contact with the substrate;
wherein the channel is configured to accommodate a portion of the wire;
wherein the channel has a depth that is less than a cross-sectional diameter of the portion of the wire;
wherein the portion of the wire and the substrate are clamped between the welding pad and the anvil during operation of the sonotrode; and
wherein the first energy directors are disposed to urge the portion of the wire towards the substrate when the sonotrode is vibrationally excited.
